(19) United States
(12) Patent Application Publication
(10) Pub. No.: US 2010/0030649 A1
(43) Pub. Date: Feb. 4, 2010

(54) METHOD AND SYSTEM FOR BATCH EXECUTION OF VARIABLE INPUT DATA

(75) Inventor: Thomas W. Ubelhor, Aurora, IL (US)

Correspondence Address: NEAL, GERBER, & EISENBERG, SUITE 1700, 2 NORTH LASALLE STREET, CHICAGO, IL, 60602, US

(73) Assignee: Trans Union LLC, Chicago, IL (US)

(21) Appl. No.: 12/493,150

(22) Filed: Jun. 26, 2009

Related U.S. Application Data
(60) Provisional application No. 61/076,483, filed on Jun. 27, 2008.

(51) Int. Cl. G06Q 30/00; G06F 17/30; G06F 17/40

(52) U.S. Cl. 705/14.66; 707/5; 707/E17.017; 707/E17.044

(57) ABSTRACT

This invention relates generally to methods and systems for batch execution of variable input data, and more particularly to methods and systems for delivering enhanced event-based marketing products to customers using an open systems approach whereby non-developers may enter and/or select various input and output criteria in a GUI environment for batch processing.

### CROSS-REFERENCE TO RELATED APPLICATION

This application claims priority from U.S. Provisional Patent Application Ser. No. 61/076483, filed Jun. 27, 2008, which is incorporated herein by reference in its entirety.

### BACKGROUND OF THE INVENTION

This invention relates generally to methods and systems for batch execution of variable input data, and more particularly to methods and systems for delivering enhanced event-based marketing products to customers using an open systems approach whereby non-developers may enter and/or select various input and output criteria in a GUI environment for batch processing.

The consumer lending industry bases its decisions to grant credit or loans, or to give consumers preferred credit or loan terms, on the general principle of risk, i.e., risk of non-repayment. Essentially, credit and lending institutions typically avoid granting credit or loans to high risk consumers, or grant credit or lending to such consumers at higher interest rates or other terms less favorable than those typically granted to consumers with low risk. Credit scores are the well-known industry measures of credit risk, such as the VantageScoreSM credit score or the FICO credit score, and are typically based on proprietary algorithms and statistical analyses of consumer data that result in a scoring number within a given range, such as, for example, 501-990. This number correlates to a probability of negative performance and acts as a predictor of credit risk, where the higher the credit score, the less risk posed, and vice-versa. In conjunction with credit scores, most credit and lending institutions also employ other underwriting criteria to evaluate the credit risk presented by credit and loan applicants, and approve or reject those applicants based on that evaluation. If the applicant is approved, the lender will offer a pricing structure that reflects the risk presented by that customer, so that an appropriate risk-return dynamic is maintained.

Sometimes lenders may wish to offer credit, such as new credit card accounts, to customers meeting certain lending criteria, for example, via one or more mass marketing campaigns. Rather than sending advertising material to every household in the country, lenders may instead wish to provide advertising materials to a targeted population out of the universe of people who the lenders could potentially extend credit. To do this, lenders may want the total population filtered based on certain variables, such as household geographic location, risk of default, etc. In addition, lenders may want the filtered data expressed in a unique format for integration into the lender's computer systems.

To meet individual lender input and output requirements, credit reporting companies typically must write and employ a number of uniquely prepared software programs to access the credit reporting companies' databases. This process, however, is labor intensive and does not easily permit use of the same software programs by the credit reporting companies for each of their lender-customers.

The present invention solves this problem by providing methods and systems for entering variable input and output selection criteria for batch processing one or more consumer data databases irrespective of differing lender input and output criteria.

### SUMMARY OF THE INVENTION

In one embodiment, a computer system for determining a plurality of consumers qualified to receive marketing materials is disclosed, comprising a database comprising consumer credit data stored on a mainframe computer system, an open systems computer system, and sharing software that transforms the consumer credit data to and from a mainframe format and an open systems format to permit computer operations on the consumer credit data by either the mainframe computer system or the open systems computer system. The open systems computer system comprises a user interface for receiving variable input data, credit scoring software for credit scoring the consumer credit data, and filtering software for filtering the scored consumer credit data based on the input data to determine the plurality of consumers qualified to receive marketing materials.

The consumer credit data may comprise credit account data, public record data, and collections data. The computer system may further comprise software for determining differences in consumer credit data from one batch run to the next. The computer system may also comprise software for combining fragmented consumer credit records into a single record for each consumer.

A method for determining a plurality of consumers qualified to receive marketing materials is also disclosed, comprising updating a database comprising consumer credit data stored on a mainframe computer system with current consumer credit data, determining the differences between the current consumer credit data and the previously stored consumer credit data to form difference data, passing the difference data from a mainframe computer system to an open systems computer system, scoring the difference data to update the credit score for each consumer in the database, and filtering the scored difference data to obtain the plurality of consumers qualified to receive marketing materials.

### BRIEF DESCRIPTION OF THE DRAWINGS

For a better understanding of the invention, reference may be had to preferred embodiments shown in the following drawings in which:

FIG. 1 is a flow diagram describing the layers of functionality that are changed or created from a baseline system to support one embodiment of the present invention;

FIG. 2 is an open systems model diagram describing the architecture and operation of the present invention.

### DETAILED DESCRIPTION

The description that follows describes, illustrates and exemplifies one or more particular embodiments of the present invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the present invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers in cases where such labeling facilitates a more clear description. Additionally, the drawings set forth herein are not necessarily drawn to scale, and in some instances proportions may have been exaggerated to more clearly depict certain features.

In accordance with the principles of the present invention, one or more algorithms or analyses may be applied, alone or in combination, to a set of data to produce a tangible and useful result indicative of authorized-user-related issues. In a particular embodiment, characteristics are defined and determined for a specific set of data, resulting in useful statistics indicative of authorized-user-related issues. Data for specific files may be processed in light of these characteristics and an output specific to those files and related to those characteristics can be generated for use and analysis, which will be described in more detail later.

The present invention enables credit reporting companies to deliver enhanced event-based marketing products to its customers, such as credit card issuers and the like. Event based marketing systems and methods allow credit reporting companies to identify changes in a consumer's credit file—events that often precede the need for new or additional services to be provided or to reduce exposure to losses by lenders.

By monitoring these events, marketers (i.e., lenders, credit card issuers and the like) can greatly improve the performance of their acquisition, cross sell and loyalty marketing campaigns along with helping them to minimize risk of loss. Data output from credit reporting companies' existing systems, which are based on massive mainframe databases that run batch queries, already provide marketers with information on a daily, weekly, or as needed basis to enhance their lists, adjust their product offerings, and improve the performance of their various marketing campaigns. However, increases in the volume of data and the complexity of the mainframe systems have added to the processing time and the high operating cost of such systems. In addition, such mainframe-based systems require creation of marketer-specific software to permit marketer-specific data mining, filtering, and output requirements for each particular marketing campaign.

The present invention addresses these key challenges by enhancing mainframe systems to provide these services without having to create and/or reprogram software interfaces that connect with these systems. The present invention accomplishes this by transforming existing mainframe systems to an open systems environment, which reduces mainframe CPU usage and provides a flexible tool for entering customer-unique input and output requirements without needing to create or revise interface software to meet differing requirements of each marketer.

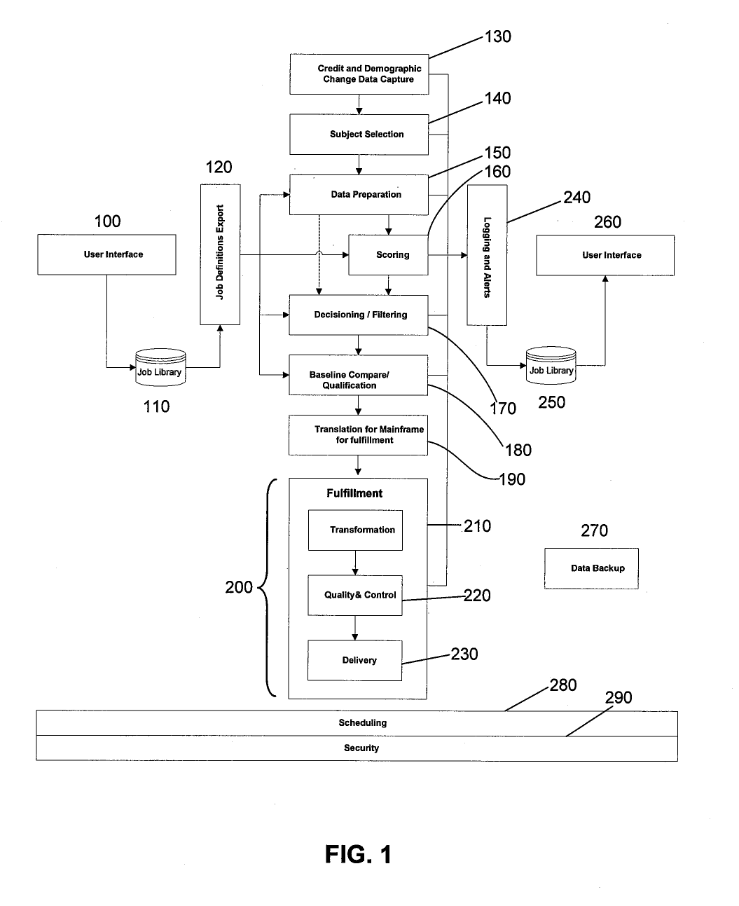

Turning now to the figures, wherein like reference numerals refer to like elements, there is illustrated in FIG. 1 various modifications to representative mainframe systems to incorporate the improvements of the present invention. FIG. 1 illustrates, for example, user interface 100, which may comprise a graphical user interface (GUI) for entering and/or collecting variable input information for batch execution. The minimum data that must be captured is:
Posting code of the customers (i.e., marketers, lenders, credit card issuers, etc.) subscribing to data reporting system of the credit reporting company. The codes are needed for business and compliance validations as well as for inquiry posting, and billing.
Type of job per customer. The system may be designed to support various job types, such as Account Solicitation and Account Review job types. The Account Solicitation job type is specified for customers who wish to expand their portfolio by finding new consumers to offer credit to. The Account Review job type is specified for customers who wish to monitor their current accounts and extend offers, such as lower interest rates, to consumers in good standing. Job type is a critical piece of information along with a customer's posting code because together they determine the give-to-get logic that must be applied to a job. Give-To-Get logic guarantees that a customer is only allowed to use credit data elements they supply to the credit bureau.
Criteria, by customer, to be applied to the changed data for filtering down the population.
Models, by customer, to be used in criteria or output during fulfillment steps.
Frequency to apply the criteria and baseline compares. The batch system needs to know if the criteria for a given customer must be applied daily, weekly, monthly or on some other interval.
Frequency for updating the baseline data. The system must know by customer, how often and which data on the baseline must be updated.

User interface 100 interacts with job library 110 to facilitate retrieval and storage of data pertaining to a job. The batch system will update the job library 110 with the execution results of the batch stream so the results can be displayed and used by user interface 100.

Data making up the definition of all of the jobs to be executed for a given night may be exported out of the database and stored in an XML document, as shown by job definition export service 120 of FIG. 1. The XML document may be made available to a batch scheduler to drive execution of the batch stream. The XML document may dictate, for example, which models to be executed, the time and/or order for execution, the criteria to apply against the data, the fully qualified path to the various data files, and the file layouts.

Change data capture service 130 of FIG. 1 represents recognition and capture of changes to database records using software that produces a list of consumers whose credit data in the database has changed since, for example, the day before. As some records in a source database (a database containing the credit information of all U.S. consumers) may be “fragmented,” a complete “credit picture” of an individual may not be readily available. One example of how a record may become fragmented is when a consumer moves to a new address. If a consumer moves from 555 West St., Chicago Ill. to 123 Green St., Springfield Mich. and if the system's match logic does not immediately determine that the credit data it just received is in fact for the same person, the record is considered to be fragmented. During batch processing additional software is employed to search for and resolve fragmented records for all individuals.

Subject selection service 140 of FIG. 1 represents an optional service to incorporate a predetermined list of consumers upon which the job is run. Such list may be supplied by the customer, for example.

Data preparation service 150 of FIG. 1 prepares the captured data for subsequent credit scoring and decisioning/filtering processes. For example, an extract, transform, and load (“ETL”) operation may be performed on the output from the first layer which is the changed data pulled from the source database and reformatted into Model Data Record (“MDR”) files. MDR records contains data represented in a format that helps facilitate the execution of models against the data. The output from data preparation service 150 is fed into decisioning/filter service 160, as shown in FIG. 1.

Scoring service 160 of FIG. 1 is a service that uses various software programs for executing models against consumer data. For example, one software program may join together the minimum amount of consumer data needed for model processing and package it into a physical MDR record. The physical MDR record may then be submitted to the scoring service 160 for processing. Scoring service 160 may then pass the consumer data to the requested models and save the results into another physical MDR file. An MDR conversion process may then take output from scoring service 160 and split it into separate files based on model name and give-to-get type.

Decisioning/filter service 170 of FIG. 1 performs filtering by utilizing a “decision” service. The “decision” service may consume the output from the MDR file generation and conversion steps along with the input criteria entered for each job online and may filter the data down to one or more data files, as may be requested by the customer. Decisioning/filter service 170 may append customer defined tags to the records in the data files if requested.

Baseline compare/qualification service 180 of FIG. 1 compares the output from decisioning/filter service 170 against a baseline dataset, applying qualification logic entered by the user. If the record meets the qualification criteria, the record will be marked for acceptance and the baseline dataset will be updated with current values.

Translation for the mainframe 190 of FIG. 1 represents an optional transformation step to transfer the filtered and accepted population to the mainframe and transform it to a format useable by a fulfillment stream. This process will only run if fulfillment must be performed on the mainframe.

Fulfillment service 200 of FIG. 1 consumes the file(s) produced by the previous layers to produce a single file for presentation to the customer. The file can be prepared in any format the customer needs and/or specifies. Fulfillment service 200 may provide additional filtering and/or transformation steps on the data, such as screening the changed database for consumers who have opted out of receiving targeted marketing materials.

Logging and alerts service 240 of FIG. 1 may receive the output from change data capture service 130, subject selection service 140, data preparation service 150, scoring service 160, baseline compare/qualification service 180, and fulfillment service 200, and is designed to produce log files detailing the number of records in, the number of records out, the amount of CPU time consumed and the status of each process (success or failure). Logging and alerts service 240 will capture this information and store it in a database so it can be mined at a later time. Status messages, such as queued, running, complete, failure, may be reported by each component and may be used to alert the user as to the progress of the batch stream. The output from logging and alerts service 240 may be stored in job library 250, as shown in FIG. 1. Security 290 of FIG. 1 provides restricted access to online input screens. Open systems access is controlled by Novell's Lightweight Directory Access Protocol (LDAP) product for the Linux and AIX operating systems. Computer Associate's Access Control Facility (ACF2) product will be used to control access to mainframe datasets and the mainframe database.

Scheduling service 280 of FIG. 1 may use various software, such as the commercially available Computer Associates Jobtrac and AutoSys products, to tie the various services together into one seamless batch stream and to schedule job execution. For example, Jobtrac may be used for scheduling components for execution on the mainframe, and AutoSys may be used for scheduling jobs for execution on open systems components. Components such as decisioning/filter service 170 and scoring service 160 may be run iteratively simply by modifying the schedule to invoke these components multiple times and by passing in a different control file for each iteration.

Data backup service 270 of FIG. 1 may backup the contents of job library 250, including the output from change data capture service 130 and baseline compare/qualification service 180, on mainframe tape or other media. The customer baseline files may be backed up to open systems tape or other media.

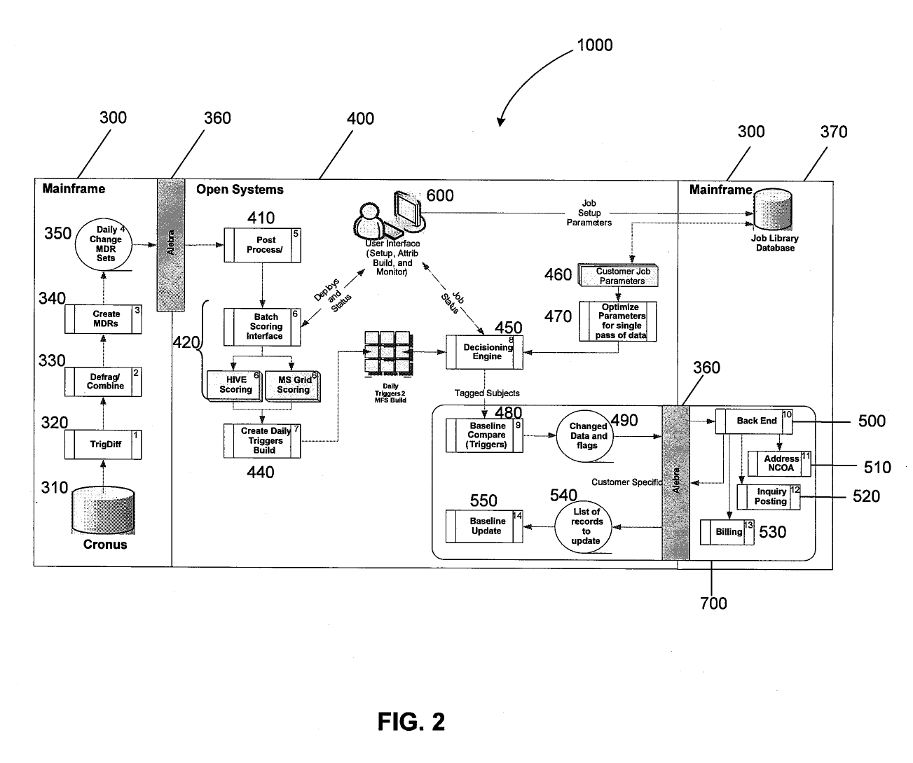

Turning to FIG. 2, there is shown an open systems model 1000 for interfacing with a credit reporting company's mainframe to carry out the present invention. For example, as shown in FIG. 2, open systems model 1000 may include mainframe elements 300 and open system elements 400. As shown in FIG. 2, open systems model 1000 is centered on user interface 600, where input and output parameters are set and where monitoring of batch runs is performed.

The architecture of open systems model 1000 permits efficient interaction with mainframe elements 300 to easily enter varying input and output parameters and/or constraints for multiple batch runs—all without having to write unique software code to manually interface with the mainframe for each batch job run.

As shown in FIG. 2, mainframe elements 300 may include, for example, mainframe database 310 comprising consumer credit data including credit accounts, public records, and collections, software 320 capable of determining differences in mainframe database 310 from one batch run to the next, software 330 capable of combining fragmented consumer records into a single record for each consumer, and software 340 capable of reformatting mainframe database 320 data into an MDR record that is stored in a file for later transmission to open systems processing using software 360 usable for this purpose. Mainframe elements 300 may also include job library 370 for storing, for example, various job setup parameters that are input by a user using user interface 600. Job library 370 may be updated with the execution results of the batch stream so the results can be displayed and used by user interface 600. The job setup parameters are eventually passed to decision engine 450, as described more fully below, to filter consumer credit data according to customer specifications.

As shown in FIG. 2, open system elements 400 may include user interface 600, post processing software 410 to prepare data transferred from mainframe elements 300 for credit scoring using batch scoring software 420, decision engine 450 usable for filtering the scored consumer credit data stream according to customer specifications to create a list of individual consumers from which a baseline credit comparison may be made, and fulfillment elements 700 for, for example, determining and flagging changed data, enhancing the data using a customer specification, resolving differences in consumer mailing addresses, determining and processing billing services, and updating consumer credit records.

A key element to creating an open systems interface platform, as depicted in FIG. 2, is software 360, which transfers data to and from mainframe elements 300 to open system elements 400. In one embodiment, software 360 may comprise Alebra software available from Alebra Technologies located in Minneapolis, Minn.

In operation, consumer credit data from yesterday, for example, may be compared against new or updated consumer credit data from today, for example, using software 320, as shown in FIG. 2. The results of this comparison may be output to a file of “differences.” Records with fragmented data may then be combined back into a single record, as shown using software 330. From here, the data may be reformatted into an MDR record and written to yet another file. The MDR records are then transferred to open system elements 400 of open system model 1000 using software 360 for further processing.

Once the data file has been transferred to open system elements 400 using software 360, software 410 may land the data in a multi-file system for post processing in preparation of passing the data through credit scoring using batch scoring software 420. In one embodiment, a suitable multi-file system may comprise a product called Ab Initio, which is available from Ab Initio Software Corporation of Lexington, MA. Batch scoring software 420 may comprise proprietary algorithms and methodologies for rating individual consumer's credit worthiness according to one or more proprietary rating systems and/or rating scales.

Once consumer credit data records are scored, the data is passed to decision engine 450 for filtering the scored consumer credit data stream according to customer specifications input in user interface 600 and stored in job library 370. Such customer specifications may include customer-specific parameters for filtering the consumer credit data. The parameters may be input into user interface 600, which may comprise an open systems graphical user interface (GUI).

Using the filter criteria, decision engine 450 filters the scored consumer credit data stream, the output of which comprises a list of individuals upon which a baseline compare may be run. As shown in FIG. 2, the baseline compare step 480 may be employed to compare a consumer's credit data against a previous snapshot of the data to determine if the consumer qualifies to be passed to fulfillment elements 700 for transmitting customer-specific marketing materials, such as credit card offers, to such qualified consumers.

If a particular consumer qualifies to receive marketing materials, then the consumer's credit data record is passed to fulfillment elements 700, which are part of mainframe elements 300. This is accomplished using software 360 to transform the data from an open systems format to a format compatible for operation by the mainframe. In one embodiment, as described above, software 360 may comprise Alebra software available from Alebra Technologies located in Minneapolis, Minn. The data may be further enhanced using customer-specific criteria, and any consumer address disagreements may be resolved using address standardization algorithms at this time. As shown in FIG. 2, posting an inquiry to a consumer's record at step 520 and customer billing at step 700 may be performed using statistics taken from the fulfillment data stream regarding the consumers who were fulfilled according to customer specifications.

Lastly, depending on customer criteria entered into user interface 600 for when baseline data record should be updated stored, baseline data is updated on a customer by customer basis after execution of each fulfillment processing stream, as shown in FIG. 2.

Each component in open systems model 1000 may be programmed to output and store performance metrics for real-time and/or post execution analysis of each batch job. Such metrics may include: the number of records in, the number of records out, the start time, the end time, and execution status (success or failure). Other component-specific metrics may also be gathered and stored to measure system and job execution performance.

While specific embodiments of the invention have been described in detail, it will be appreciated by those skilled in the art that various modifications and alternatives to those details could be developed in light of the overall teachings of the disclosure. Accordingly, the particular invention disclosed is meant to be illustrative only and not limiting as to the scope of the invention which is to be given the full breadth of the appended claims and any equivalents thereof.

What is claimed is:

1. A computer system for determining a plurality of consumers qualified to receive marketing materials, comprising:
a database comprising consumer credit data stored on a mainframe computer system;
an open systems computer system, comprising
a user interface for receiving variable input data;
credit scoring software for credit scoring the consumer credit data; and
filtering software for filtering the scored consumer credit data based on the input data to determine the plurality of consumers qualified to receive marketing materials; and
sharing software that transforms the consumer credit data to and from a mainframe format and an open systems format to permit computer operations on the consumer credit data by either the mainframe computer system or the open systems computer system.

2. The system of claim 1, wherein the consumer credit data comprises credit account data, public record data, and collections data.

3. The system of claim 1, further comprising software for determining differences in consumer credit data from one batch run to the next.

4. The system of claim 1, further comprising software for combining fragmented consumer credit records into a single record for each consumer.

5. A method for determining a plurality of consumers qualified to receive marketing materials, comprising:
updating a database comprising consumer credit data stored on a mainframe computer system with current consumer credit data;
determining the differences between the current consumer credit data and the previously stored consumer credit data to form difference data;
passing the difference data from a mainframe computer system to an open systems computer system;
scoring the difference data to update the credit score for each consumer in the database; and
filtering the scored difference data to obtain the plurality of consumers qualified to receive marketing materials.
